(19) United States
(12) Patent Application Publication
(10) Pub. No.: US 2002/0178802 A1
(43) Pub. Date: Dec. 5, 2002

(54) Scanning probe microscope and method of processing signals in the same

(76) Inventor: Norio Ookubo, Tokyo (JP)

Correspondence Address: SCULLY, SCOTT, MURPHY & PRESSER, 400 Garden City Plaza, Garden City, NY, 11530, US

(21) Appl. No.: 10/212,639

(22) Filed: Aug. 5, 2002

Related U.S. Application Data
(62) Division of application No. 09/833,511, filed on Apr. 12, 2001.

(30) Foreign Application Priority Data
Apr. 13, 2000 (JP) 112478/2000

(51) Int. Cl. G01B 5/28; H01J 47/00

(52) U.S. Cl. 73/105; 250/305

(57) ABSTRACT

A scanning probe microscope includes (a) a first device which causes a relative displacement between an object and a probe, (b) a detector which detects a change in interaction caused by the first device between the probe and the object, (c) a second device which feeds the detected change back to the relative displacement to keep the interaction equal to a constant, (d) an adder which adds the detected change to the constant while the interaction is fed back to a distance between the probe and the object, to thereby temporarily vary the constant, (e) a collector which collects signals relating to a displacement which signals are varied as the constant is varied, and calculates a relation among the signals, and (f) a third device which returns the temporarily varied constant back to the constant for scanning the object, calculates products of the relation with each of the signals in real-time, and sums the products, which products indicate a profile of a surface of the object.

### BACKGROUND OF THE INVENTION

1. Field of the Invention

The invention relates to a scanning probe microscope and a method of processing signals in a scanning probe microscope.

2. Description of the Related Art

A scanning probe microscope is designed to have a probe having a sharpened tip end. The scanning probe microscope scans a surface of an object through the sharpened tip end to thereby detect interaction between the probe and the object. Then, the scanning probe microscope controls a distance between the probe and the object to be equal to a constant, based on the detected interaction, and keeps on transmitting control signals indicative of a distance between the probe and the object. Based on the control signals, a shape of the object's surface is visualized.

A scanning probe microscope which is designed to detect a tunnel current as interaction between a probe and an object is called a scanning tunneling microscope (STM). A scanning probe microscope which is designed to detect a force exerted between a probe and an object is generally called an atomic force microscope (AFM).

When electric or magnetic interaction between a probe and an object is to be detected by means of a scanning probe microscope, the scanning probe microscope is required to have a function to carrying out a feedback control to a distance between a probe and an object in order to uniformize dynamic interaction between a probe and an object. Under such a feedback control, the scanning probe microscope scans a surface of an object to thereby electrically or magnetically carry out detection.

A scanning probe microscope includes an actuator to actuate a probe for controlling a distance between a probe and an object. The actuator is generally comprised of a piezoelectric device. An area to be scanned by a probe is, for instance, 10 μm×10 μm, and a displacement by which a probe has to be displaced in order to compensate for an inclination and/or irregularities of an object is in the range of 0 to about 5 μm.

In order to accomplish the above-mentioned scanning area and displacement, a typical piezoelectric device is generally designed to have either a cylindrical shape having a height in the range of about 5 to 9 cm and an outer diameter equal to or smaller than 1 cm, or a tripod-shape.

A piezoelectric device generally has a fundamental frequency for resonance at about 5 kHz or smaller, due to a size or a complicated structure thereof. Accordingly, when a surface of an object is scanned, a range of a frequency in which a distance between a probe and an object can be controlled is limited to about 5 kHz or smaller. This means that a scanning speed is also limited.

As a result, it takes a long time, specifically 5 to 8 minutes per one image, to have a shape of a surface of an object with high reliability, based on control signals transmitted from a probe. If a scanning speed is increased in order to reduce a time necessary for forming an image, fidelity of an image to a shaped of a surface of an object is degraded, resulting in degradation of an image.

That is, the above-mentioned feedback control cannot catch up with a scanning speed, resulting in that a probe makes collision with an object, and accordingly, a probe and/or an object are damaged. In addition, it would become quite difficult to detect an electric characteristic of an object by means of an electrically conductive probe with high reliability, because interaction between the probe and the object varies.

A frequency band of a signal transmitted from a probe is generally different from a frequency band of a piezoelectric device. For instance, a frequency band of a current signal in a scanning tunneling microscope (STM) is broader by columns than a frequency band in which a piezoelectric device is operable.

Japanese Patent No. 2713717 (Japanese Unexamined Patent Publication No. 1-206202) has suggested a method of forming an image of a shape of a surface of an object, based on the above-mentioned difference. Specifically, the suggested method has a step of calculating a linear sum of a signal transmitted from a probe and a signal to be transmitted to a piezoelectric device to thereby increase a scanning speed.

A probe may be arranged at one end of a cantilever. When a signal derived from a displacement of the probe is to be detected, based on a principle of an optical lever, it would be possible, by selecting a probe, to make a frequency band of a signal transmitted from the probe broader than a frequency band in which a piezoelectric device controlling a distance between an object and the probe is operable.

Japanese Unexamined Patent Publication No. 2-5339 has suggested a method of a controlling a distance between an object and a probe by means of two actuators. In the method, a displacement caused by an inclination of an object is compensated for by means of an inch warm. A probe is arranged on a tripod complex piezoelectric device to thereby compensate for a displacement of the probe caused by irregularities existing on a surface of an object.

Japanese Unexamined Patent Publication No. 10-311841 has suggested a method of scanning a surface of an object. In the method, there are used a first actuator having a high operation speed and a second actuator having a low operation speed for making it possible to scan a surface having high irregularities.

Japanese Unexamined Patent Publication No. 10-10140 has suggested a method of scanning a shape of a surface of an object. In the suggested method, different frequencies in a displacement of a probe caused when irregularities on a surface of an object are scanned by means of two or more piezoelectric devices are compensated for. Images of the irregularities are formed by control signals transmitted to the piezoelectric devices.

Japanese Unexamined Patent Publication No. 11-201977 has suggested a method of using both a signal to be input into a feedback system and a signal in the feedback system. It is assumed that a feedback system receives a signal A, a signal P is produced by applying conversion allowed in the feedback system, to the signal A, and an output signal transmitted from a device to which the signal P is input is negatively fed back to the signal A. The method includes the step of synthesizing the signal A and the signal P.

However, it is quite difficult or almost impossible to rapidly have an image reflecting a shape of a surface of an object even by the above-mentioned conventional methods or scanning probe microscopes some of which includes a plurality of actuators.

In order to accomplish high-speed scanning, when a displacement of a probe, indicative of irregularities existing on a surface of an object, is restored to a constant through the use of a plurality of control signals and/or probe signals transmitted from a probe which control signals and probe signals are complementary with each other, it is necessary to have a relation among those signals with high accuracy and as readily as possible.

In general, a displacement of a probe is detected by an optical signal detected under a principle of an optic lever. Hence, a displacement of a probe is dependent on many parameters such as a geometric structure of an optic lever, an amount of a light, an optic reflectance of a cantilever having an end on which a probe is arranged, and/or a photoelectric transfer ratio of a photodetector.

Furthermore, an electric-mechanical conversion rate at which a piezoelectric device converts a control signal into a displacement is dependent on stability of a piezoelectric device, and hence, has to be frequently calibrated.

Hence, when an image of a shape of a surface of an object is to be formed at a high speed through the use of a signal indicative of a displacement of a probe and a control signal transmitted from a probe, even if requisite coefficients can be obtained through calibration, it would not be practical to keep those coefficients equal to a constant, and it would be quite difficult to ensure reliability in target coefficients.

In order to make it possible to more practically use a scanning probe microscope at a high speed, it would be important to measure a relation among signals relating to a displacement of a probe, under the same conditions as conditions in which a displacement is actually measured.

One of methods for having an image of a shape of a surface of an object at a high speed may include the steps of compensating for a displacement of a probe by means of a plurality of actuators, and obtaining the image, based on control signals to be input into the actuators.

However, the method in which two piezoelectric devices are used, suggested in Japanese Unexamined Patent Publication No. 10-10140, is accompanied with a problem that even though a signal is transmitted in division through a plurality of feedback routes, control signals overlapping each other in a low frequency band may be included in two feedback routes, resulting in unstable operation of a scanning probe microscope.

In the method suggested in Japanese Unexamined Patent Publication No. 10-10140, a sum of control signals to be transmitted to two piezoelectric devices are merely calculated in order to form an image of a shape of a surface of an object. However, since electric-mechanical conversion rates of two piezoelectric devices are different from each other, it would be impossible to accurately form the image merely by summing control signals to each other. Specifically, it would be necessary for the method to include steps of dividing a feedback route into a plurality of routes, and restoring signals indicative of a displacement caused by irregularities existing on a surface of an object, through the use of control signals being transmitted through the divided feedback routes.

A method of accomplishing high-speed scanning through the use of two actuators is suggested, for instance, in Review of Scientific Instruments, 64,692, 1993.

As mentioned above, the conventional scanning probe microscopes and methods of forming an image of a shape of a surface of an object are accompanied with a problem that a feedback control to be carried out by a plurality of controllers and a signal processing for obtaining the image, both of which are required to be compatible with high-speed scanning, are not well established.

A scanning capacity microscope detects a capacity between a surface of an object and an electrode located below the surface. However, such a capacity cannot be readily detected. In particular, when a surface of an object below which an electrode is formed has great irregularities and is composed of dielectric material, it would be necessary to control a distance between a probe and a surface of an object such that the distance is kept equal to a constant, in order to scan and detect a capacity per a unit area of an object. As a result, it would take much time to have an image relating to a capacity in comparison with a time necessary for obtaining an image of irregularities of a surface of an object.

Hence, it is important to reduce a time necessary for carrying out a control on a distance between a probe and an object, in order to rapidly obtain an image in a scanning capacity microscope. If the time could be reduced, it would be possible to rapidly obtain not only an image of a capacity but also an image of irregularities of a surface of an object.

### SUMMARY OF THE INVENTION

In view of the above-mentioned problems in the prior art, it is an object of the present invention to provide a scanning probe microscope and a method of processing signals in a scanning probe microscope both of which are capable of reducing a time necessary for forming an image of a surface of an object with a resolution being kept high.

In one aspect of the present invention, there is provided a method of processing a signal in a scanning probe microscope, including the steps of (a) causing a relative displacement between an object and a probe, (b) detecting a change in interaction caused between the probe and the object by the relative displacement, (c) feeding the detected change back to the relative displacement to keep the interaction equal to a constant, the method further including the steps of (d) adding the detected change to the constant while the interaction is fed back to a distance between the probe and the object, to thereby temporarily vary the constant, the step (d) being to be carried out before scanning the object, (e) collecting signals relating to a displacement which signals are varied as the constant is varied, and operating a relation among the signals, and (f) returning the temporarily varied constant back to the constant for scanning the object, calculating products of the relation with each of the signals in real-time, and summing the products, which products indicate a profile of a surface of the object.

In another aspect of the present invention, there is provided a scanning probe microscope including (a) a first device which causes a relative displacement between an object and a probe, (b) a detector which detects a change in interaction caused by the first device between the probe and the object, (c) a second device which feeds the detected change back to the relative displacement to keep the interaction equal to a constant, (d) an adder which adds the detected change to the constant while the interaction is fed back to a distance between the probe and the object, to thereby temporarily vary the constant, (e) a collector which collects signals relating to a displacement which signals are varied as the constant is varied, and calculates a relation among the signals, and (f) a third device which returns the temporarily varied constant back to the constant for scanning the object, calculates products of the relation with each of the signals in real-time, and sums the products, which products indicate a profile of a surface of the object.

For instance, the detector may operate with the probe being kept in contact with the object. As an alternative, the detector may operate with the probe making periodical contact with the object.

It is preferable that the detector, when the probe is driven at dynamical resonance or in the vicinity of dynamical resonance, detects a resonance characteristic of the dynamical resonance.

For instance, the probe may be comprised of an electrically conductive probe, and further including a detector which detects an electric capacity existing between the electrically conductive probe and the object, the electrically conductive probe acting as an open end or a leakage end in an electric resonance system, the detector detecting a resonance characteristic caused by electric interaction between the probe and the object.

As an alternative, the probe may be comprised of an electrically conductive probe, and further including a detector which detects an electric capacity existing between the electrically conductive probe and the object, the electrically conductive probe acting as an open end or a leakage end in an electric resonance system, the detector detecting a resonance characteristic caused by electric interaction between the probe and the object, with a voltage applied to the object, being varied.

There is further provided a scanning probe microscope including (a) a first device which causes a relative displacement between an object and a probe, (b) a detector which detects a change in interaction caused by the first device between the probe and the object, (c) a second device which feeds the detected change back to the relative displacement to keep the interaction equal to a constant, (d) a third device which varies the constant while the change is being fed back to the relative displacement and the object is not being scanned, (e) a calculator which calculates a change rate of a first signal relative to a second signal, the first signal being transmitted from the probe and varied as the constant is varied, the second signal being transmitted from the third device, and (f) a fourth device which synthesizes the first and second signals in real-time to thereby transmit a third signal indicative of a profile of a surface of the object, based on the change rate.

It is preferable that the third device includes means for adding a signal varying with the lapse of time, to the constant.

For instance, the calculator may be comprised of (e1) an analog-digital converter which converts analog signals relating to a displacement which signals are varied as the constant is varied, into digital signals when the object is not being scanned, (e2) an arithmetic unit which calculates a change rate among the thus analog-digital converted signals, (e3) a memory which stores the change rate, and (e4) means for transferring the change rate.

For instance, the fourth device may be comprised of (f1) a receiver which receives a change rate of a first signal to a second signal, the first signal being a reference signal selected among signals relating to a displacement which signals are varied as the constant is varied, the second signal being a signal other than the reference signal among the signals, (f2) at least one multiplier which calculates a product of the change rate with real-time signals each relating to a displacement associated with the change rate, and (f3) an adder which calculates either a sum of the reference signal and an output transmitted from the multiplier or a sum of outputs transmitted from a plurality of the multipliers.

It is preferable that the multiplier includes a digital-analog converter which multiplies digital and analog signals with each other.

There is still further provided a scanning probe microscope including (a) a first device which causes a relative displacement between an object and a probe, (b) a detector which detects a change in interaction caused by the first device between the probe and the object, (c) a second device which feeds the detected change back to the relative displacement to keep the interaction equal to a constant, (d) a third device which varies the constant while the change is being fed back to the relative displacement and the object is not being scanned, (e) a calculator which calculates change rates of a first signal relative to each of a plurality of second signals, the first signal being transmitted from the probe and varied as the constant is varied, the second signals being transmitted from the third device, and (f) a fourth device which returns the temporarily varied constant back to the constant for scanning the object, and synthesizes the first and second signals in real-time to thereby transmit a third signal indicative of a profile of a surface of the object.

For instance, the second device may include (c1) a low-pass filter and a high-pass filter which are complementary with each other and which divide a signal indicative of the change, and (c2) an actuator driven in accordance with the signal.

It is preferable that the scanning probe microscope further includes an amplifier which amplifies the signal, the actuator being driven in accordance with the thus amplified signal.

For instance, the second device may include (c1) a first actuator driven in accordance with a first signal indicative of the change, (c2) a low-pass filter providing low frequency parts of the first signal, and (c3) a second actuator driven in accordance with a second signal transmitted from the low-pass filter.

It is preferable that the second device further includes an amplifier for amplifying the first signal, the first actuator being driven in accordance with the thus amplified first signal.

There is yet further provided a scanning probe microscope including (a) a first device which causes a relative displacement between an object and a probe, (b) a detector which detects a change in interaction caused by the first device between the probe and the object, (c) a second device which feeds the detected change back to the relative displacement to keep the interaction equal to a constant, (d) a measurement device which measures a displacement caused by the second device and transmits a first signal indicative of the displacement, (e) a third device which varies the constant while the change is being fed back to the relative displacement and the object is not being scanned, (f) a calculator which calculates change rates of the first signal relative to each of second signals, the first signal being varied in accordance with a displacement caused by the third device, the second signals being independent of the measurement device, and (f) a fourth device which synthesizes the first and second signals in real-time to thereby transmit a third signal indicative of a profile of a surface of the object, based on the change rates.

There is still yet further provided a scanning probe microscope including (a) a first device which causes a relative displacement between an object and a probe, (b) a detector which detects a change in interaction caused by the first device between the probe and the object, and (c) a second device which feeds the detected change back to the relative displacement to keep the interaction equal to a constant, the second device including (c1) a low-pass filter and a high-pass filter which are complementary with each other and which divide a signal indicative of the change, and (c2) an actuator driven in accordance with the signal.

It is preferable that the scanning probe microscope further includes an amplifier which amplifies the signal, the actuator being driven in accordance with the thus amplified signal.

There is further provided a scanning probe microscope including (a) a first device which causes a relative displacement between an object and a probe, (b) a detector which detects a change in interaction caused by the first device between the probe and the object, and (c) a second device which feeds the detected change back to the relative displacement to keep the interaction equal to a constant, the second device including (c1) a first actuator driven in accordance with a first signal indicative of the change, (c2) a low-pass filter providing low frequency parts of the first signal, and (c3) a second actuator driven in accordance with a second signal transmitted from the low-pass filter.

It is preferable that the second device further includes an amplifier for amplifying the first signal, the first actuator being driven in accordance with the thus amplified first signal.

The advantages obtained by the aforementioned present invention will be described hereinbelow.

In accordance with the present invention, when a displacement indicative of irregularities existing on a surface of an object is to be restored by a plurality of signals such as a control signal indicative of a displacement used for compensating for a displacement of a probe caused by irregularities existing on a surface of an object, a probe signal transmitted from a probe, and an output signal indicative of a displacement caused by a controller, a relation among those signals is determined while a control for compensating for a displacement of a probe is in operation, prior to scanning a surface of an object. When a surface of an object is scanned, a displacement corresponding to irregularities existing on a surface of an object is synthesized from the thus determined relation and real-time signals. This ensures high-speed scanning.

It is assumed that the above-mentioned control and probe signals include a signal indicative of a displacement of a probe, transmitted from the probe, and a control signal transmitted to an actuator, and a feedback control is in operation to a predetermined constant. In accordance with the present invention, a signal having a periodically varying waveform, such as a waveform in the form of teeth of a saw, a triangle waveform or a waveform in the form of a sine curve, is added to the constant before starting scanning a surface of an object. Then, a signal transmitted from a probe, indicative of variation in the constant, and the control signal are collected. Then, a relation among those signals is calculated and stored in a memory. When a surface of an object is actually scanned, a real-time signal transmitted from a probe and the control signal are synthesized to thereby form an image reflecting irregularities existing on a surface of an object, based on the stored relation among the above-mentioned signals. Herein, the signal transmitted from a probe and the control signal transmitted to an actuator are signals relating to a displacement and having different frequency bands from each other.

When the above-mentioned signals relating to a displacement are control signals in a plurality of controllers, signals in frequency bands to which each of the signals belongs are added to the above-mentioned predetermined constant while all feedback systems are in operation, before starting scanning a surface of an object. Then, control signals which vary relative to the constant to which the above-mentioned signals have been added, and a detection signal transmitted from a probe are collected. Then, a relation among the signals is calculated, and is stored in a memory. When a surface of an object is actually scanned, a signal indicative of irregularities existing on a surface of an object is synthesized from the above-mentioned real-time signals relating to a displacement. Thus, an image is obtained in a scanning probe microscope.

When the above-mentioned signals relating to a displacement include a signal indicative of a displacement caused by one of controllers, signals in frequency bands to which each of the above-mentioned signals belong are added to the predetermined constant while all feedback systems are in operation, before scanning a surface of an object. Then, a signal varying in accordance with a change in the constant, and a control signal transmitted from a controller having no measurement unit are collected. Then, a relation between the thus collected signals and the signals in frequency bands is calculated, and is stored in a memory. When a surface of an object is actually scanned, a signal indicative of irregularities existing on a surface of an object is synthesized from the above-mentioned signal indicative of a displacement caused by one of controllers, and the control signal transmitted from the controller having no measurement unit. Thus, an image is obtained in a scanning probe microscope.

When a distance between a probe and an object is fed back to a displacement of a probe by means of a plurality of controllers in order to compensate for a signal transmitted from a probe, in order to ensure stability in each of feedback routes, it is necessary to avoid interference in the feedback routes.

To this end, a signal transmitted from a probe is divided into two parts with respect to a frequency band by means of low-pass and high-pass filters which are complementary with each other. An amplifier is arranged for each of the parts. Herein, division of a signal means that a signal is divided into two parts without a loss with respect to a frequency band, and a sum of the thus divided parts would make the original signal.

In one method of avoiding interference among the feedback routes, a signal transmitted from a probe is amplified, and the thus amplified signal is input into an actuator driven in a high frequency band. The actuator is driven with the control signal having passed through a low-pass filter in order to compensate for a low frequency part in a displacement caused by the actuator.

A signal having a periodically varying waveform, such as a waveform in the form of teeth of a saw, a triangle waveform or a waveform in the form of a sine curve, is added to the constant while the feedback control is in operation, before starting scanning a surface of an object, in order to calibrate a relation among the signals relating to a displacement. Then, responses of the signals are collected.

A device for varying the constant may be comprised of a waveform synthesizer for transmitting a signal having a periodically varying waveform, and an adder for adding the signal to the constant.

The scanning probe microscope may receive a plurality of signals relating to a displacement which signals vary as the constant varies, and calculates a change rate of a first signal to a second signal. Herein the first signal is a reference signal selected among the signals relating to a displacement which signals are varied as the constant is varied, and the second signal is a signal other than the reference signal among the signals. The scanning probe microscope may include a memory to store both a band of a signal which can be described with the change rate, and the change rate therein.

As a synthesizer for synthesizing a signal indicative of irregularities existing on a surface of an object, in real-time, while the surface is being scanned and a feedback control is in operation, the scanning probe microscope may include means for receiving a change rate of a first signal to a second signal, the first signal being a reference signal selected among signals relating to a displacement which signals are varied as the constant is varied, the second signal being a signal other than the reference signal among the signals, calculating a product of said change rate with the change rate with real-time signals each relating to a displacement associated with the change rate, and calculating either a sum of the reference signal and an output transmitted from the multiplier or a sum of outputs transmitted from a plurality of the multipliers.

In order to operate the above-mentioned synthesizer in real-time, the scanning probe microscope preferably includes a circuit which multiplies digital and analog signals with each other. Herein, the digital data includes the above-mentioned change rate, and the analog signal includes a real-time signal relating to the change rate. A result of the multiplication is output as a real-time analog signal. The scanning probe microscope may include an operational amplifier to carry out summing analog signals.

Among the above-mentioned methods, the method in which a plurality of controllers is used is applicable to probes carrying out various operations. In a contact mode where a probe is kept in contact with a surface of an object, and in a tapping mode where a probe periodically makes contact with a surface of an object, the method is applicable also to a method including the steps of arranging a probe on a small-sized crystal oscillator, putting the oscillator in a dynamic resonance condition, and detecting a resonance parameter varying due to interaction between a probe and an object.

When interaction between a probe and an object is to be controlled at a high speed, electric interaction between a probe and an object may be detected to do so.

In a scanning capacity microscope where a probe is embedded in a micro-wave oscillator, and a distance between a probe and an object or a capacity in a piece of a surface of an object with a probe being kept in contact with an object is detected as a change in micro-wave oscillation, it would be possible to scan a surface of an object at a high speed through the use of a plurality of controllers.

It would be also possible to scan a surface of an object at a high speed by detecting a change in micro-wave resonance with a voltage applied to a electrode located below the surface of an object, being varied, namely, by detecting dC/dV.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a scanning probe microscope in accordance with the first embodiment of the present invention.

FIG. 2 is a block diagram of a scanning probe microscope in accordance with the second embodiment of the present invention.

FIG. 3A is a block diagram of a control block including low- and high-pass filters which are complementary with each other.

FIG. 3B is a block diagram of a control block for transmitting two control signals.

FIG. 4 is a block diagram of a scanning probe microscope in accordance with a variant of the second embodiment of the present invention.

FIG. 5 is a block diagram of a scanning probe microscope in accordance with the third embodiment of the present invention.

FIG. 6 is a circuit diagram of a scanning probe microscope in accordance with the fourth embodiment of the present invention.

FIG. 7 is a block diagram of a scanning probe microscope in accordance with the fifth embodiment of the present invention.

FIG. 8 is a block diagram of a scanning probe microscope in accordance with the sixth embodiment of the present invention.

### DESCRIPTION OF THE PREFERRED EMBODIMENTS

Preferred embodiments in accordance with the present invention will be explained hereinbelow with reference to drawings.

[First Embodiment]

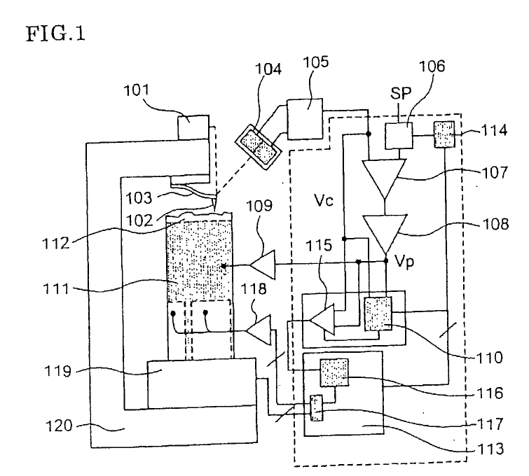

With reference to FIG. 1, a laser beam emitted from a laser source 101 is received in a probe 102 supported on a free end of a cantilever 103. The laser beam is reflected at the probe 102 to and is detected in a divided photodetector 104. The laser beam received in the divided photodetector 104 is output as a probe signal Vc through a circuit 105 for detecting a position of the probe 102.

The probe signal Vc is input into a first input port of an error amplifier 107. On the other hand, a signal SP indicative of a predetermined constant is input into a second input port the error amplifier 107 through an adder 106.

A signal output from the error amplifier 107 is input into a low-pass filter 108, and output from the low-pass filter 108 as a signal Vp, which is input into both a high-voltage amplifier 109 and an operation and memory unit 110.

The high-voltage amplifier 109 outputs a signal to a piezoelectric device 111. The piezoelectric device 111 controls a distance between an object 112 and the probe 102 such that the probe signal Vc is equal to the signal SP. This feedback control keeps a distance between the object 112 and the probe 102 equal to a constant.

The piezoelectric device 111 is in the form of a cylinder having a diameter of 12 mm, a height of 90 mm and a thickness of 1 mm. The piezoelectric device 111 has a dynamic resonance frequency of about 2 kHz. The low-pass filter 108 has a cut-off frequency in the range of 400 to 700 Hz both inclusive.

As mentioned above, a distance between the probe 102 and the object 112 is feedback-controlled to the predetermined constant so as to ensure steady interaction between the probe 102 and the object 112.

Before starting scanning a surface of the object 112, a controller 113 instructs a waveform synthesizer 114 to synthesize a variable signal and transmit the variable signal to the adder 106. For instance, the waveform synthesizer 114 produces a signal having a waveform in the form of teeth of a saw and having a frequency which can pass through the low-pass filter 108.

The feedback control makes the probe signal Vc have the same waveform as the above-mentioned waveform in the form of teeth of a saw. Specifically, the piezoelectric device 111 is made to be extended or contracted to thereby cause a displacement in the probe 102, deformation of the cantilever 103, and then, a change in the probe signal Vc.

Pairs of the probe signal Vc and the signal Vp are stored in the operation and memory unit 110. The probe signal Vc is described with a polynomial of the signal Vp, and a range of the signal Vp described with the linear expression and a linear differential coefficient dVc/dVp are stored in the operation and memory unit 110.

The above-mentioned process is displayed on a display screen 116 equipped in the controller 113.

The feedback control is being carried out successively without a pause in a condition initially set.

Then, scanning a surface of the object 112 starts. Before the scanning starts, the controller 113 stops the operation of the waveform synthesizer 114, and instructs the waveform synthesizer 114 to supply a zero voltage to the adder 106.

Data stored in the operation and memory unit 110 can be read out therefrom. The read-out data is transmitted to an image signal synthesizer 115.

A scanning signal generator 117 equipped in the controller 113 transmits a scanning signal, which is amplified by a high-voltage amplifier 118 and then input into the piezoelectric device 111.

The probe 102 scans a surface of the object 112.

A frequency part in the probe signal Vc, which gradually varies as a surface of the object 112 is scanned, such as a frequency part derived from an inclination of the object 112 or a frequency part derived from small irregularities, passes through the error amplifier 107 and the low-pass filter 108, and is output therefrom as the signal Vp. The signal Vp is input into the piezoelectric device 111 for compensating for the probe signal Vc.

Accordingly, the probe signal Vc includes the rest of frequency parts, that is, a high frequency part such as a frequency part derived from steep irregularities existing on a surface of the object 112.

The image signal synthesizer 115 receives the linear differential coefficient dVc/dVp from the operation and memory unit 110, and calculates a product of the linear differential coefficient and the signal Vp. The image signal synthesizer 115 gives an alarm in dependence on a range of the signal Vp.

An output signal transmitted from the image signal synthesizer 115 is not but a signal scaled by the probe signal Vc and indicative of irregularities existing on a surface of the object 112. This output signal is displayed as an image on the display screen 116 in synchronization with a scanning signal.

FIG. 1 illustrates the scanning probe microscope which is in contact mode where the probe 102 is kept in contact with the object 112.

In contact mode, the probe signal Vc is indicative of a displacement of the cantilever 103, that is, a degree of bent of the cantilever 103.

As an alternative, the probe signal Vc may be designed to indicate an amplitude of oscillation of the cantilever 103 which amplitude can be obtained when the cantilever 103 is positioned in the vicinity of resonance condition which can put others in a resonance condition, and hence, the probe 102 periodically makes contact with a surface of the object 112.

As an alternative, the probe signal Vc may indicate a phase of a compulsive force of the oscillation.

As an alternative, if the probe 102 is fixed to a crystal oscillator located in the vicinity of resonance condition, the probe signal Vc may indicate an impedance of the oscillator.

[Second Embodiment]

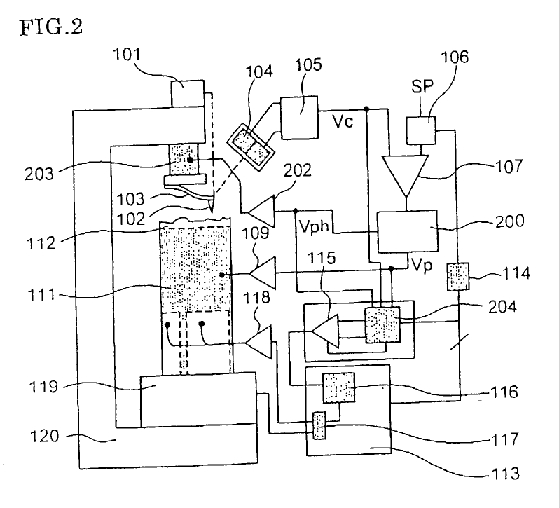

FIG. 2 is a block diagram of a scanning probe microscope in accordance with the second embodiment of the present invention.

The scanning probe microscope in accordance with the second embodiment is designed to include two actuators for carrying out high-speed scanning.

The scanning probe microscope in accordance with the second embodiment includes the entire structure of the scanning probe microscope in accordance with the first embodiment, illustrated in FIG. 1, and additionally includes a control block 200 which transmits two control signals, a second piezoelectric device 203, a power amplifier 202 which drives the second piezoelectric device 203, and an operation and memory unit 204 which monitors the probe signal Vc transmitted from the probe 102, a control signal Vp transmitted to the piezoelectric device 111 from the control block 200, and a control signal Vph transmitted to the second piezoelectric device 203 from the control block 200.

The piezoelectric device 111 has a resonance frequency of about 2 kHz.

The second piezoelectric device 203 has a multi-layered structure at a size of 3×4×5 mm, and has a resonance frequency of about 70 kHz.

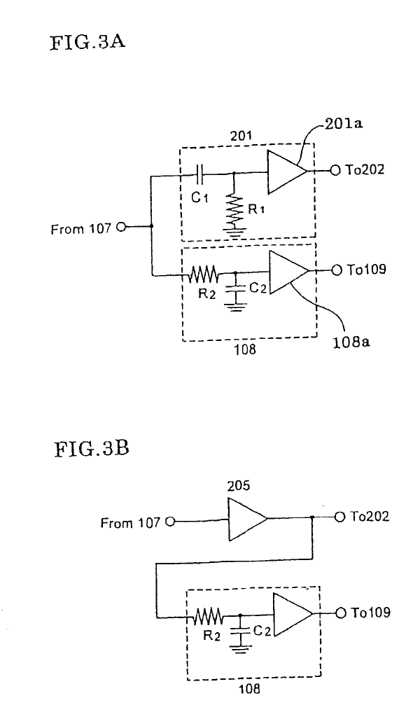

The control block 200 may be comprised of a pair of filters complementary with each other. An example of the control block 200 is illustrated in FIG. 3A.

As illustrated in FIG. 3A, the control block 200 may be comprised of a low-pass filter 108 and a high-pass filter 201 complementary with the low-pass filter 108.

The probe signal Vc transmitted from the probe 102 passes through the error amplifier 107, and then, is divided into a low-frequency signal Vp to be transmitted to the piezoelectric device 111 and a high-frequency signal Vph to be transmitted tot he second piezoelectric device 203.

The high-pass filter 201 is comprised of a capacitor C1 which receives the probe signal Vc from the error amplifier 107, a resistor R1 which is grounded at one end and electrically connected to a node between the capacitor C2 and an amplifier 201a, and an amplifier 201a which is electrically connected at an input port to both the capacitor C1 and the resistor R1.

The low-pass filter 108 is comprised of a resistor R2 which receives the probe signal Vc from the error amplifier 107, a capacitor C2 which is grounded at one end and electrically connected to a node between the resistor R2 and an amplifier 108a, and an amplifier 108a which is electrically connected at an input port to both the capacitor C2 and the resistor R2.

In the high-pass filter 201, the capacitor C1 and the resistor R1 cooperates with each other to thereby constitute a filter. In the low-pass filter 108, the resistor R2 and the capacitor C2 cooperates with each other to thereby constitute a filter.

The resistors R1, R2 and the capacitors C1, C2 are selected such that the following equation is established.

R1×C1=R2×C2=τ

Herein, “τ” indicates a period of time obtained by multiplying a time defined as an inverse number of a resonance frequency of the piezoelectric device 111, by 3 or 4.

FIG. 3B illustrates another example of the control block 200.

The control block 200 is comprised of the low-pass filter 108 and an amplifier 205 which receives the probe signal Vc from the error amplifier 107, and transmits an output signal to both the high-voltage amplifier 202 and the resistor R2.

The probe signal Vc transmitted from the probe 102 passes through the error amplifier 107, and then, is input as a control signal Vph into the high-voltage amplifier 202 which drives the second piezoelectric device 203.

A low frequency part in the control signal Vph is separated in the low-pass filter 108, and is input into the piezoelectric device 111 as a control signal Vp.

A displacement of the piezoelectric device 111 caused by the control signal Vp compensates for a displacement in a low frequency band among a displacement of the second piezoelectric device 203. Though not illustrated, the control signal Vph is filtered in the high-pass filter 201 so that the control signal Vph has a resonance frequency equal to or smaller than a resonance frequency of the second piezoelectric device 203, and then, is input into the high-voltage amplifier 202.

A relation among a plurality of signals relating to a displacement is determined under a feedback control as follows.

The probe 102 and a surface of the object 112 interact with each other. When a distance between the probe 102 and the object 112 is feed-back controlled such that the probe signal Vc transmitted from the probe 102 is steady at a predetermined constant, the controller 113 instructs the waveform synthesizer 114 to synthesize a variable signal and transmit the thus synthesized variable signal to the adder 106, prior to scanning a surface of the object 112. For instance, the waveform synthesizer 114 produces a signal having a waveform in the form of teeth of a saw and having a frequency which can pass through the low-pass filter 108.

The feedback control makes the probe signal Vc have the same waveform as the above-mentioned waveform in the form of teeth of a saw. Specifically, the piezoelectric device 111 is made to be extended or contracted to thereby cause a displacement in the probe 102, deformation of the cantilever 103, and then, a change in the probe signal Vc.

Pairs of the probe signal Vc and the signal Vp are stored in the operation and memory unit 204. The probe signal Vc is described with a polynomial of the signal Vp, and a range of the signal Vp described with the linear expression and a linear differential coefficient dVc/dVp are stored in the operation and memory unit 204.

The above-mentioned process is displayed on the display screen 116 equipped in the controller 113.

Then, the controller 113 instructs the waveform synthesizer 114 to generate a voltage having a high frequency which cannot pass through the low-pass filter 108. In response, the waveform synthesizer 114 generates a voltage having a sine-curve waveform.

The feedback control makes the probe signal Vc have the same waveform as the above-mentioned since-curve waveform. Specifically, the second piezoelectric device 203 is made to be extended or contracted to thereby cause a displacement in the probe 102, deformation of the cantilever 103, and then, a change in the probe signal Vc.

Pairs of the probe signal Vc transmitted from the probe 102 and the signal Vph transmitted from the high-pass filter 201 are stored in the operation and memory unit 204. The probe signal Vc is described with a polynomial of the signal Vph, and a range of the signal Vph described with the linear expression and a linear differential coefficient dVc/dVph are stored in the operation and memory unit 204.

The feedback control is being carried out successively without a pause at the initially set constant.

Then, the controller 113 stops the operation of the waveform synthesizer 114, and instructs the waveform synthesizer 114 to supply a zero voltage to the adder 106.

Data dependent on the signals Vp and Vph, stored in the operation and memory unit 204 can be read out therefrom. The read-out data is transmitted to the image signal synthesizer 115.

Then, the controller 113 instructs the scanning signal generator 117 to transmit a scanning signal, which is amplified by the high-voltage amplifier 118, and then, input into the piezoelectric device 111.

Then, the probe 102 starts scanning a surface of the object 112.

A frequency part in the probe signal Vc, which gradually varies as a surface of the object 112 is scanned, such as a frequency part derived from an inclination of the object 112 or a frequency part derived from small irregularities, passes through the error amplifier 107 and the low-pass filter 108, and is output therefrom as the signal Vp. The signal Vp is input into the piezoelectric device 111 for compensating for the probe signal Vc.

The rest of frequency parts in the probe signal Vc, that is, a high frequency part such as a frequency part derived from steep irregularities existing on a surface of the object 112, is input into the error amplifier 107 and output therefrom as the control signal Vph. The control signal Vph is input into the second piezoelectric device 203 for controlling the second piezoelectric device 203, and compensates for a high frequency part of the probe signal Vc.

The image signal synthesizer 115 receives the linear differential coefficients dVc/dVp and dVc/dVph from the operation and memory unit 204, and calculates a product of the linear differential coefficients and the real-time signals Vp and Vph. The image signal synthesizer 115 gives an alarm if the signal Vp or Vph is in a band which is necessary to be compensated for with high-order paragraphs.

An output signal transmitted from the image signal synthesizer 115 is not but a signal scaled by the probe signal Vc and indicative of irregularities existing on a surface of the object 112. This output signal is displayed as an image on the display screen 116 in synchronization with the scanning signal.

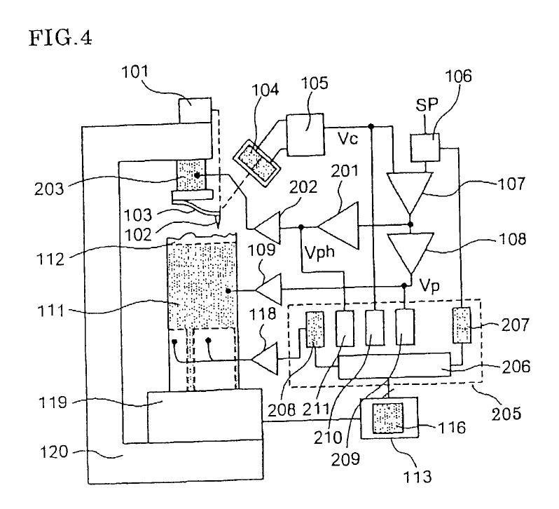

FIG. 4 illustrates a variant of the scanning probe microscope in accordance with the second embodiment, illustrated in FIG. 2.

The scanning probe microscope illustrated in FIG. 4 is designed to include a digital signal processor (DSP).

With reference to FIG. 4, the digital signal processor 205 is comprised of a first digital-analog (D-A) converter 206, a second digital-analog converter 207, a first analog-digital (A-D) converter 208, a second analog-digital converter 209, and a third analog-digital converter 210.

The digital signal processor 205 is controlled by the controller 113.

The first digital-analog converter 206 transmits a signal which is to be added to the predetermined constant through the adder 106, before scanning a surface of the object 112. By adding the signal, the constant is varied.

The second digital-analog converter 207 transmits a scanning signal by which a surface of the object 112 is scanned.

At the stage before scanning a surface of the object 112 does not start, the first to third analog-digital converters 208, 209 and 210 receives the signal Vp transmitted from the low-pass filter 108 and varied in accordance with a signal transmitted from the first digital-analog converter 206, the probe signal Vc transmitted from the probe 102, and the control signal Vph, and converts these analog signals into digital data.

At the stage while a surface of the object 112 is being scanned, the first to third analog-digital converters 208, 209 and 210 receives the signals Vp, Vc and Vph which are all varied as the object 112 is scanned, and converts the analog signals Vp, Vc and Vph into digital signals.

The thus analog-digital converted signals Vp, Vc and Vph are input into the digital signal processor 205.

At the stage when the feedback control is in operation and before scanning a surface of the object 112 does not start, the digital signal processor 205 receives the digital data or the analog-digital converted signals Vp, Vc and Vph, calculates a change rate of the probe signal Vc to the signal Vp or Vph, further calculates bands of the signals Vp and Vph which bands can be described with the associated change rate, and stores the thus calculated change rates and bands therein.

At the stage while a surface of the object 112 is being scanned, the digital signal processor 205 receives the digital data or the analog-digital converted signals Vp, Vc and Vph which are all varied as the object 112 is scanned, and then, judges whether bands of the signals Vp, Vc and Vph are described with the stored change rates.

If the bands are not described with the stored change rates, the digital signal processor 205 gives an alarm. If the bands are described with the stored change rates, the digital signal processor 205 multiplies the differential coefficients dVp/dVc and dVph/dVc by each other. Herein, the differential coefficients dVp/dVc and dVph/dVc are associated with the digital data derived from the signal Vp and Vh, respectively. Then, the digital signal processor 205 scales the products to the probe signal Vc, adds the products to each other, and transmits the sum to the controller 113.

The data transmitted to the controller 113 is displayed on the display screen 116.

The scanning probe microscope illustrated in FIG. 4 is designed to include the digital signal processor 205 as well as the controller 113. However, it should be noted that the digital signal processor 205 may be omitted, in which case, the controller 113 is designed to include the first and digital-analog converters 206 and 207, and the first to third analog-digital converters 208, 209 and 210 so as to have the functions of the digital signal processor 205.

In the above-mentioned second embodiment, the control signals Vp and Vph are scaled to the probe signal Vc. However, it should be noted that the control signals Vp and Vph may be scaled to any one the signals Vp, Vph and Vc. As an alternative, when a mechanical-electric conversion coefficient of the piezoelectric device 111 is used, it would be possible to display an image having actual dimensions, on the display screen 116.

In the above-mentioned second embodiment, low-frequency signals are first added to each other in order to determine a relation between the control signals Vp and Vc both transmitted to the piezoelectric device 111, and then, high-frequency signals are added to each other in order to determine a relation between the control signals Vph and Vc both transmitted to the second piezoelectric device 203. Namely, the relation among the signals relating to a displacement is determined one by one.

As an alternative, the relation between the control signals may be determined as follows.

While the feedback control is in operation and a surface of the object 112 is not scanned, a signal in a low frequency band to which the control signal Vp belongs and a signal in a high-frequency band to which the control signal Vph are synthesized to each other in the waveform synthesizer 114. The thus synthesized signal is added to the predetermined constant. Then, the control signals Vp and Vph are concurrently detected for determining the relation.

When a surface of the object 112 is scanned, it would be possible to synthesize a signal indicative of irregularities existing on a surface of the object 112 which signal is scaled to the control signal Vp or Vph, based on the relation.

[Third Embodiment]

FIG. 5 illustrates a scanning probe microscope in accordance with the third embodiment.

The scanning probe microscope in accordance with the third embodiment has a measurement unit for measuring a displacement caused by a plurality of controllers. Specifically, the measurement unit measures a displacement of a movable end of an actuator on which the object 112 is mounted.

With reference to FIG. 5, the scanning probe microscope includes a displacement measurement unit 301 for measuring a displacement of the object 112 relative to a base 120. The displacement measurement unit 301 transmits a signal “z” indicative of the displacement to the operation and memory unit 204. That is, the signal “z” is substituted for the control signal Vp transmitted to the piezoelectric device 111 in the second embodiment.

The probe 102 and a surface of the object 112 interact with each other. When a distance between the probe 102 and the object 112 is feed-back controlled such that the interaction between the probe 102 and the object 112 is steady, the controller 113 instructs the waveform synthesizer 114 to synthesize a variable signal and transmit the thus synthesized variable signal to the adder 106, prior to scanning a surface of the object 112. For instance, the waveform synthesizer 114 produces a signal having a waveform in the form of teeth of a saw and having a frequency which can pass through the low-pass filter 108.

The feedback control makes the probe signal Vc have the same waveform as the above-mentioned waveform in the form of teeth of a saw. Specifically, the piezoelectric device 111 is made to be extended or contracted to thereby cause a displacement in the probe 102, deformation of the cantilever 103, and then, a change in the probe signal Vc.

Pairs of the probe signal Vc and the signal “z” transmitted from the displacement measurement unit 301 are stored in the operation and memory unit 204. The probe signal Vc is described with a polynomial of the signal “z”, and a range of the signal “z” described with the linear expression and a linear differential coefficient dz/dVc are stored in the operation and memory unit 204.

The above-mentioned process is displayed on the display screen 116 equipped in the controller 113.

Then, the controller 113 instructs the waveform synthesizer 114 to generate a signal having a frequency which is in a range of the high-pass filter 201. In response, the waveform synthesizer 114 generates a signal having a sine-curve waveform.

The feedback control makes the probe signal Vc have the same waveform as the above-mentioned since-curve waveform. Specifically, the second piezoelectric device 203 is made to be extended or contracted to thereby cause a displacement in the probe 102, deformation of the cantilever 103, and then, a change in the probe signal Vc.

Pairs of the probe signal Vc transmitted from the probe 102 and the signal Vph transmitted from the high-pass filter 201 are stored in the operation and memory unit 204. The probe signal Vc is described with a polynomial of the signal Vph, and a range of the signal Vph described with the linear expression and a linear differential coefficient dVc/dVph are stored in the operation and memory unit 204.

The operation and memory unit 204 further calculates a differential coefficient dz/dVph from the differential coefficients dz/dVc and dVc/dVph, and stores the thus calculated differential coefficient dz/dVph therein. In scanning a surface of the object 112, the operation and memory unit 204 adds the real-time signal “z” transmitted from the displacement measurement unit 301, to a product of the real-time control signal Vph and the differential coefficient dz/dVph to thereby have a signal indicative of irregularities existing on a surface of the object 112 which signal is scaled to the signal “z” transmitted from the displacement measurement unit 301.

In the third embodiment, low-frequency signals are first added to each other in order to determine a relation between the probe signal Vc and the signal “z”, and then, high-frequency signals are added to each other in order to determine a relation between the control signal Vc and the control signal Vph transmitted to the second piezoelectric device 203 driven in a high frequency band. Namely, the relation among the signals relating to a displacement is determined one by one.

As an alternative, the relation between the signals may be determined as follows.

While the feedback control is in operation and a surface of the object 112 is not scanned, a signal in a low frequency band to which the signal “z” belongs and a signal in a high-frequency band to which the control signal Vph are synthesized to each other in the waveform synthesizer 114. The thus synthesized signal is added to the predetermined constant. Then, the signals “z” and Vph are concurrently detected for determining the relation.

When a surface of the object 112 is scanned, it would be possible to synthesize a signal indicative of irregularities existing on a surface of the object 112 which signal is scaled to the signal “z” or Vph, based on the relation.

[Fourth Embodiment]

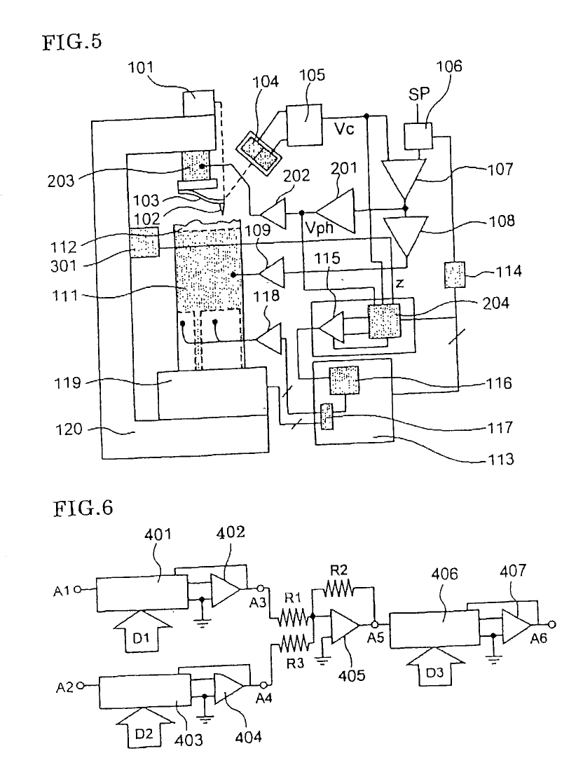

FIG. 6 illustrates a scanning probe microscope in accordance with the fourth embodiment.

In the fourth embodiment, the image synthesizer 115 is comprised of a digital-analog converter (DAC) having a function of carrying out multiplication. In accordance with the fourth embodiment, it is possible to synthesize a signal indicative of irregularities existing on a surface of the object 112, in real-time, based on a plurality of real-time signals relating to a displacement.

With reference to FIG. 6, real-time analog signals A1 and A2 relating to a displacement are input into first and second digital-analog converters 401 and 403, respectively. The first and second digital-analog converters 401 and 403 receives digital input signals D1 and D2, respectively, and weighs currents having amplitudes which are in proportion to amplitudes of the analog signals A1 and A2, with the digital input signals D1 and D2. The thus weighed currents are converted into analog voltage signals A3 and A4 in operational amplifiers 402 and 404. The analog voltage signals A3 and A4 indicate the products having been calculated in the first and second digital-analog converters 401 and 403.

In the above-mentioned first embodiment, the analog signal A1 corresponds to the probe signal Vc transmitted from the probe 102, and the analog signal A2 corresponds to the control signal Vp transmitted to the piezoelectric device 111. The digital input signal D1 corresponds to a digital signal having a weight of one (1), and the digital input signal D2 corresponds to a digital signal indicative of the differential coefficient dVc/dVp read out of the operation and memory unit 110.

In the above-mentioned second embodiment, the analog signal A1 corresponds to the control signal Vp transmitted to the piezoelectric device 111, and the analog signal A2 corresponds to the control signal Vph transmitted to the second piezoelectric device 203. The digital input signal D1 corresponds to a digital signal indicative of the differential coefficient dVc/dVp, and the digital input signal D2 corresponds to a digital signal indicative of the differential coefficient dVc/dVph.

In the above-mentioned third embodiment, the analog signal A1 corresponds to the signal “z” transmitted from the displacement measurement unit 301, indicating extension or contraction of the piezoelectric device 111.

In all of the first to third embodiments, the analog signals A3 and A4 are added in the same weight by an operational amplifier 405. That is, resistors R1, R2 and R3 are equal to one another (R1=R2=R3), and have a resistance of about 10 k ω.

As a result, an analog signal A4 transmitted from the operational amplifier 405 indicates a voltage linear to irregularities existing on a surface of the object 112, in the first to third embodiments.

In the fourth embodiment, the scanning probe microscope further includes a digital-analog converter 406 receiving a digital signal D3 and having a function of carrying out multiplication, and an operational amplifier 407 which transmits an analog signal A6.

When the control signals Vp (or “z”) and Vph are concurrently detected to determine a relation between those two signals, as mentioned in the above-mentioned second and third embodiments, the scanning probe microscope may include any one of the digital-analog converter 406 and the operational amplifier 407. Of course, the scanning probe microscope may include both the digital-analog converter 406 and the operational amplifier 407.

That is, if the real-time signal Vp (or “z”) as the analog signal A1 is input into the first digital-analog converter 401, the differential coefficient dVph/dVp (or dVph/dz) as the digital signal D1 is input also to the first digital-analog converter 401, the control signal Vph as the analog signal A2 is input into the second digital-analog converter 403, and the digital signal D2 is designed to be digital data equivalent to one (1), the analog signal A6 would be a real-time signal indicative of irregularities existing on a surface of the object 112.

[Fifth Embodiment]

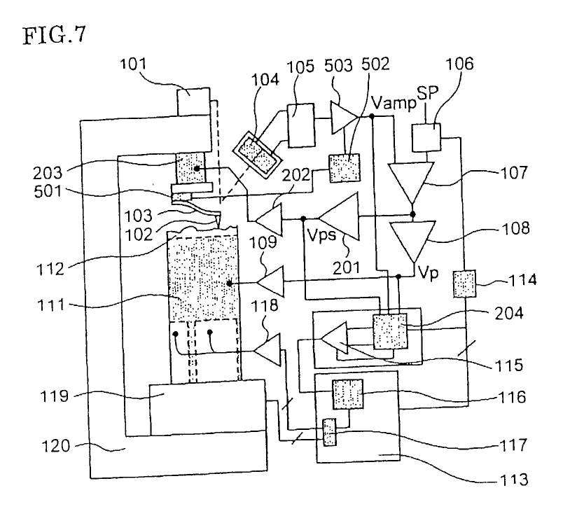

FIG. 7 illustrates a scanning probe microscope in accordance with the fifth embodiment.

The scanning probe microscope in accordance with the fifth embodiment is designed to include a third piezoelectric device 501 on which the cantilever 103 is fixed at a proximal end of the cantilever 103. The probe 102 is fixed on the cantilever 103 at a distal end of the cantilever 103.

The third piezoelectric device 501 oscillates the cantilever 103 at the proximal end at a frequency close to a resonance frequency of the probe 102. Hence, an amplitude of the distal end of the cantilever 103, that is, a displacement of the probe 102 varies in dependence on interaction between the probe 102 and a surface of the object 112.

The third piezoelectric device 501 receives a voltage signal having a sine-curve waveform, from a signal transmitter 502, and accordingly, oscillates the cantilever 103 at the proximal end of the cantilever 103 at a frequency in the vicinity of a resonance frequency of the probe 102.

In the fifth embodiment, the resonance frequency is about 300 kHz. The signal transmitter 502 transmits the voltage signal to the third piezoelectric device 501, and at the same time, transmits data about a phase of the voltage signal to a lock-in amplifier 503.

A laser beam emitted from a laser source 101 is directed to the probe 102, and is reflected at the probe 102. The reflected laser beam is detected in a divided photodetector 104, and then, is input into a circuit 105 for detecting a position of the probe 102. The circuit 105 transmits a voltage signal having a sine-curve waveform and indicative of a displacement of the probe 102.

The lock-in amplifier 503 detects a phase of the voltage signal transmitted from the circuit 105, and transmits an amplitude signal Vamp indicative of a displacement of the probe 102 in a sine curve.

A predetermined constant SP together with the amplitude signal Vamp is input into the error amplifier 107. The error amplifier 107 transmits a signal Vp to both the high-voltage amplifier 109 and the operation and memory unit 204 through the low-pass filter 108.

The high-voltage amplifier 109 transmits a signal to the piezoelectric device 111. In accordance with the signal transmitted from the high-voltage amplifier 109, a distance between the object 112 and the probe 102 is controlled such that the predetermined constant SP is coincident with the amplitude signal Vamp. This feedback control keeps the distance equal to a constant.

The piezoelectric device 111 has the same size as the size of the piezoelectric device 111 in the first embodiment. The resonance frequency and a cut-off frequency of the low-pass filter 108 are identical with those in the first embodiment.

[Sixth Embodiment]

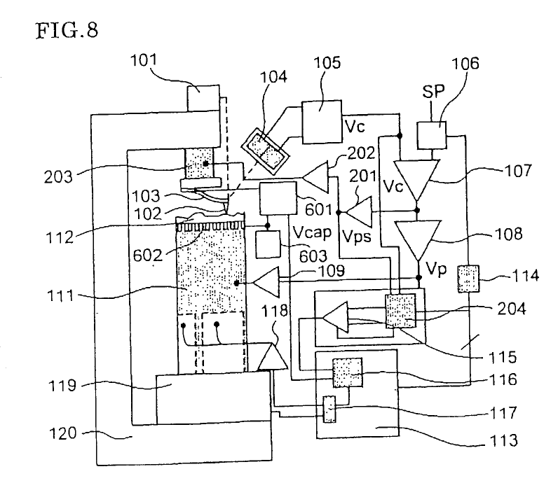

FIG. 8 illustrates a scanning capacity microscope in accordance with the sixth embodiment.

The scanning capacity microscope in accordance with the sixth embodiment includes the entire structure of the scanning probe microscope in accordance with the second embodiment, and additionally includes a sensor 601 which senses an electric capacity, a plurality of electrodes 602 arranged below the object 112, and a circuit 603 which applies a bias to the electrodes 602.

In scanning a surface of the object 112, a signal Vcap transmitted from the sensor 601, indicative of an electric capacity sensed by the sensor 601, is collected to thereby form an image of irregularities existing on a surface of the object 112.

A relation among the signals Vc, Vp and Vph is determined, prior to scanning of a surface of the object 112, by means of the controller 113, the waveform synthesizer 114, the adder 106 and the operation and memory unit 204 in the same way as the second embodiment.

In scanning a surface of the object 112 before measurement starts, the real-time signals Vp and Vph are input into the image synthesizer 115. The image synthesizer 115 reads data such as differential coefficients out of the operation and memory unit 204, and calculates a product of the signals Vp and Vph and the thus read-out data. Then, the operation and memory unit 204 transmits a signal indicative of irregularities existing on a surface of the object 112.

The probe 102 in the sixth embodiment is composed of electrically conductive material. For instance, the probe 102 is composed of silicon nitride coated with iron and/or chromium.

The circuit 603 applies a voltage difference across the probe 102 and the electrodes 602. When a surface of the object 112 is scanned, a capacity formed between the object 112 and the probe 102 is detected by the sensor 601. The capacity is dependent on the voltage difference.

The signal indicative of irregularities existing on a surface of the object 112 and the signal Vcap transmitted from the sensor 601 and indicative of the detected capacity are received in the controller 113, and displayed on the display screen 116 equipped in the controller 113.

The scanning capacity microscope in accordance with the sixth embodiment is in a contact mode where the probe 102 is kept in contact with a surface of the object 112. However, it should be noted that the scanning capacity microscope in accordance with the sixth embodiment can be applied to a mode where a compulsive force acts on the probe 102, and hence, a displacement of the probe 102 is close to a resonance, as having been explained in the above-mentioned fifth embodiment.

As an alternative, an image of irregularities existing on a surface of the object can be scaled in actual dimensions by means of the displacement measurement unit 301 shown in the third embodiment, illustrated in FIG. 5.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2000-112478 filed on Apr. 13, 2000 including specification, claims, drawings and summary is incorporated herein by reference in its entirety.

What is claimed is:

1. A method of processing a signal in a scanning probe microscope, including the steps of:
(a) causing a relative displacement between an object and a probe;
(b) detecting a change in interaction caused between said probe and said object by said relative displacement;
(c) feeding the detected change back to said relative displacement to keep said interaction equal to a constant;
said method further including the steps of:
(d) adding said detected change to said constant while said interaction is fed back to a distance between said probe and said object, to thereby temporarily vary said constant, said step (d) being to be carried out before scanning said object;
(e) collecting signals relating to a displacement which signals are varied as said constant is varied, and operating a relation among said signals; and
(f) returning said temporarily varied constant back to said constant for scanning said object, calculating products of said relation with each of said signals in real-time, and summing said products, which products indicate a profile of a surface of said object.

2. A scanning probe microscope comprising:
(a) a first device which causes a relative displacement between an object and a probe;
(b) a detector which detects a change in interaction caused by said first device between said probe and said object;
(c) a second device which feeds the detected change back to said relative displacement to keep said interaction equal to a constant;
(d) an adder which adds said detected change to said constant while said interaction is fed back to a distance between said probe and said object, to thereby temporarily vary said constant;
(e) a collector which collects signals relating to a displacement which signals are varied as said constant is varied, and calculates a relation among said signals; and
(f) a third device which returns said temporarily varied constant back to said constant for scanning said object, calculates products of said relation with each of said signals in real-time, and sums said products, which products indicate a profile of a surface of said object.

3. The scanning probe microscope as set forth in claim 2, wherein said detector operates with said probe being kept in contact with said object.

4. The scanning probe microscope as set forth in claim 2, wherein said detector operates with said probe making periodical contact with said object.

5. The scanning probe microscope as set forth in claim 2, wherein said detector, when said probe is driven at dynamical resonance or in the vicinity of dynamical resonance, detects a resonance characteristic of said dynamical resonance.

6. The scanning probe microscope as set forth in claim 2, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object.

7. The scanning probe microscope as set forth in claim 2, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object, with a voltage applied to said object, being varied.

8. A scanning probe microscope comprising:
(a) a first device which causes a relative displacement between an object and a probe;
(b) a detector which detects a change in interaction caused by said first device between said probe and said object;
(c) a second device which feeds the detected change back to said relative displacement to keep said interaction equal to a constant;
(d) a third device which varies said constant while said change is being fed back to said relative displacement and said object is not being scanned;
(e) a calculator which calculates a change rate of a first signal relative to a second signal, said first signal being transmitted from said probe and varied as said constant is varied, said second signal being transmitted from said third device; and
(f) a fourth device which synthesizes said first and second signals in real-time to thereby transmit a third signal indicative of a profile of a surface of said object, based on said change rate.

9. The scanning probe as set forth in claim 8, wherein said third device includes means for adding a signal varying with the lapse of time, to said constant.

10. The scanning probe as set forth in claim 8, wherein said calculator is comprised of:
(e1) an analog-digital converter which converts analog signals relating to a displacement which signals are varied as said constant is varied, into digital signals when said object is not being scanned;
(e2) an arithmetic unit which calculates a change rate among the thus analog-digital converted signals;
(e3) a memory which stores said change rate; and
(e4) means for transferring said change rate.

11. The scanning probe microscope as set forth in claim 8, wherein said fourth device is comprised of;
(f1) a receiver which receives a change rate of a first signal to a second signal, said first signal being a reference signal selected among signals relating to a displacement which signals are varied as said constant is varied, said second signal being a signal other than said reference signal among said signals;
(f2) at least one multiplier which calculates a product of said change rate with real-time signals each relating to a displacement associated with said change rate; and
(f3) an adder which calculates either a sum of said reference signal and an output transmitted from said multiplier or a sum of outputs transmitted from a plurality of said multipliers.

12. The scanning probe microscope as set forth in claim 11, wherein said multiplier includes a digital-analog converter which multiplies digital and analog signals with each other.

13. The scanning probe microscope as set forth in claim 8, wherein said detector operates with said probe being kept in contact with said object.

14. The scanning probe microscope as set forth in claim 8, wherein said detector operates with said probe making periodical contact with said object.

15. The scanning probe microscope as set forth in claim 8, wherein said detector, when said probe is driven at dynamical resonance or in the vicinity of dynamical resonance, detects a resonance characteristic of said dynamical resonance.

16. The scanning probe microscope as set forth in claim 8, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object.

17. The scanning probe microscope as set forth in claim 8, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object, with a voltage applied to said object, being varied.

18. A scanning probe microscope comprising:
(a) a first device which causes a relative displacement between an object and a probe;
(b) a detector which detects a change in interaction caused by said first device between said probe and said object;
(c) a second device which feeds the detected change back to said relative displacement to keep said interaction equal to a constant;
(d) a third device which varies said constant while said change is being fed back to said relative displacement and said object is not being scanned;
(e) a calculator which calculates change rates of a first signal relative to each of a plurality of second signals, said first signal being transmitted from said probe and varied as said constant is varied, said second signals being transmitted from said third device; and
(f) a fourth device which returns said temporarily varied constant back to said constant for scanning said object, and synthesizes said first and second signals in real-time to thereby transmit a third signal indicative of a profile of a surface of said object.

19. The scanning probe microscope as set forth in claim 18, wherein said second device includes:
(c1) a low-pass filter and a high-pass filter which are complementary with each other and which divide a signal indicative of said change; and
(c2) an actuator driven in accordance with said signal.

20. The scanning probe microscope as set forth in claim 19, further comprising an amplifier which amplifies said signal, said actuator being driven in accordance with the thus amplified signal.

21. The scanning probe microscope as set forth in claim 18, wherein said second device includes:
(c1) a first actuator driven in accordance with a first signal indicative of said change;
(c2) a low-pass filter providing low frequency parts of said first signal; and
(c3) a second actuator driven in accordance with a second signal transmitted from said low-pass filter.

22. The scanning probe microscope as set forth in claim 21, wherein said second device further includes an amplifier for amplifying said first signal, said first actuator being driven in accordance with the thus amplified first signal.

23. The scanning probe microscope as set forth in claim 18, wherein said third device includes means for adding a signal varying with the lapse of time, to said constant.

24. The scanning probe microscope as set forth in claim 18, wherein said calculator is comprised of:
(e1) an analog-digital converter which converts analog signals relating to a displacement which signals are varied as said constant is varied, into digital signals when said object is not being scanned;
(e2) an arithmetic unit which calculates a change rate among the thus analog-digital converted signals;
(e3) a memory which stores said change rate; and
(e4) means for transferring said change rate.

25. The scanning probe microscope as set forth in claim 18, wherein said fourth device is comprised of.
(f1) a receiver which receives a change rate of a first signal to a second signal, said first signal being a reference signal selected among signals relating to a displacement which signals are varied as said constant is varied, said second signal being a signal other than said reference signal among said signals;
(f2) at least one multiplier which calculates a product of said change rate with real-time signals each relating to a displacement associated with said change rate; and
(f3) an adder which calculates either a sum of said reference signal and an output transmitted from said multiplier or a sum of outputs transmitted from a plurality of said multipliers.

26. The scanning probe microscope as set forth in claim 25, wherein said multiplier includes a digital-analog converter which multiplies digital and analog signals with each other.

27. The scanning probe microscope as set forth in claim 18, wherein said detector operates with said probe being kept in contact with said object.

28. The scanning probe microscope as set forth in claim 18, wherein said detector operates with said probe making periodical contact with said object.

29. The scanning probe microscope as set forth in claim 18, wherein said detector, when said probe is driven at dynamical resonance or in the vicinity of dynamical resonance, detects a resonance characteristic of said dynamical resonance.

30. The scanning probe microscope as set forth in claim 18, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object.

31. The scanning probe microscope as set forth in claim 18, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object, with a voltage applied to said object, being varied.

32. A scanning probe microscope comprising:
(a) a first device which causes a relative displacement between an object and a probe;
(b) a detector which detects a change in interaction caused by said first device between said probe and said object;
(c) a second device which feeds the detected change back to said relative displacement to keep said interaction equal to a constant;
(d) a measurement device which measures a displacement caused by said second device and transmits a first signal indicative of said displacement;
(e) a third device which varies said constant while said change is being fed back to said relative displacement and said object is not being scanned;
(f) a calculator which calculates change rates of said first signal relative to each of second signals, said first signal being varied in accordance with a displacement caused by said third device, said second signals being independent of said measurement device; and
(f) a fourth device which synthesizes said first and second signals in real-time to thereby transmit a third signal indicative of a profile of a surface of said object, based on said change rates.

33. The scanning probe microscope as set forth in claim 32, wherein said second device includes:
(c1) a low-pass filter and a high-pass filter which are complementary with each other and which divide a signal indicative of said change; and
(c2) an actuator driven in accordance with said signal.

34. The scanning probe microscope as set forth in claim 33, further comprising an amplifier which amplifies said signal, said actuator being driven in accordance with the thus amplified signal.

35. The scanning probe microscope as set forth in claim 32, wherein said second device includes:
(c1) a first actuator driven in accordance with a first signal indicative of said change;
(c2) a low-pass filter providing low frequency parts of said first signal; and
(c3) a second actuator driven in accordance with a second signal transmitted from said low-pass filter.

36. The scanning probe microscope as set forth in claim 35, wherein said second device further includes an amplifier for amplifying said first signal, said first actuator being driven in accordance with the thus amplified first signal.

37. The scanning probe microscope as set forth in claim 32, wherein said third device includes means for adding a signal varying with the lapse of time, to said constant.

38. The scanning probe microscope as set forth in claim 32, wherein said calculator is comprised of:
(e1) an analog-digital converter which converts analog signals relating to a displacement which signals are varied as said constant is varied, into digital signals when said object is not being scanned;
(e2) an arithmetic unit which calculates a change rate among the thus analog-digital converted signals;
(e3) a memory which stores said change rate; and
(e4) means for transferring said change rate.

39. The scanning probe microscope as set forth in claim 32, wherein said fourth device is comprised of:
(f1) a receiver which receives a change rate of a first signal to a second signal, said first signal being a reference signal selected among signals relating to a displacement which signals are varied as said constant is varied, said second signal being a signal other than said reference signal among said signals;
(f2) at least one multiplier which calculates a product of said change rate with real-time signals each relating to a displacement associated with said change rate; and
(f3) an adder which calculates either a sum of said reference signal and an output transmitted from said multiplier or a sum of outputs transmitted from a plurality of said multipliers.

40. The scanning probe microscope as set forth in claim 39, wherein said multiplier includes a digital-analog converter which multiplies digital and analog signals with each other.

41. The scanning probe microscope as set forth in claim 32, wherein said detector operates with said probe being kept in contact with said object.

42. The scanning probe microscope as set forth in claim 32, wherein said detector operates with said probe making periodical contact with said object.

43. The scanning probe microscope as set forth in claim 32, wherein said detector, when said probe is driven at dynamical resonance or in the vicinity of dynamical resonance, detects a resonance characteristic of said dynamical resonance.

44. The scanning probe microscope as set forth in claim 32, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object.

45. The scanning probe microscope as set forth in claim 32, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object, with a voltage applied to said object, being varied.

46. A scanning probe microscope comprising:
(a) a first device which causes a relative displacement between an object and a probe;
(b) a detector which detects a change in interaction caused by said first device between said probe and said object; and
(c) a second device which feeds the detected change back to said relative displacement to keep said interaction equal to a constant,
said second device including:
(c1) a low-pass filter and a high-pass filter which are complementary with each other and which divide a signal indicative of said change; and
(c2) an actuator driven in accordance with said signal.

47. The scanning probe microscope as set forth in claim 46, further comprising an amplifier which amplifies said signal, said actuator being driven in accordance with the thus amplified signal.

48. The scanning probe microscope as set forth in claim 46, wherein said detector operates with said probe being kept in contact with said object.

49. The scanning probe microscope as set forth in claim 46, wherein said detector operates with said probe making periodical contact with said object.

50. The scanning probe microscope as set forth in claim 46, wherein said detector, when said probe is driven at dynamical resonance or in the vicinity of dynamical resonance, detects a resonance characteristic of said dynamical resonance.

51. The scanning probe microscope as set forth in claim 46, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object.

52. The scanning probe microscope as set forth in claim 46, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object, with a voltage applied to said object, being varied.

53. A scanning probe microscope comprising:
(a) a first device which causes a relative displacement between an object and a probe;
(b) a detector which detects a change in interaction caused by said first device between said probe and said object; and
(c) a second device which feeds the detected change back to said relative displacement to keep said interaction equal to a constant,
said second device including:
(c1) a first actuator driven in accordance with a first signal indicative of said change;
(c2) a low-pass filter providing low frequency parts of said first signal; and
(c3) a second actuator driven in accordance with a second signal transmitted from said low-pass filter.

54. The scanning probe microscope as set forth in claim 53, wherein said second device further includes an amplifier for amplifying said first signal, said first actuator being driven in accordance with the thus amplified first signal.

55. The scanning probe microscope as set forth in claim 53, wherein said detector operates with said probe being kept in contact with said object.

56. The scanning probe microscope as set forth in claim 53, wherein said detector operates with said probe making periodical contact with said object.

57. The scanning probe microscope as set forth in claim 53, wherein said detector, when said probe is driven at dynamical resonance or in the vicinity of dynamical resonance, detects a resonance characteristic of said dynamical resonance.

58. The scanning probe microscope as set forth in claim 53, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object.

59. The scanning probe microscope as set forth in claim 53, wherein said probe is comprised of an electrically conductive probe, and further comprising a detector which detects an electric capacity existing between said electrically conductive probe and said object,
said electrically conductive probe acting as an open end or a leakage end in an electric resonance system,
said detector detecting a resonance characteristic caused by electric interaction between said probe and said object, with a voltage applied to said object, being varied.
